(19) United States
(12) Patent Application Publication
(10) Pub. No.: US 2024/0232530 A1
(43) Pub. Date: Jul. 11, 2024

(54) SENTENCE STRUCTURE ANALYSIS SYSTEM

(71) Applicant: TOYOTA JIDOSHA KABUSHIKI KAISHA, Toyota-shi (JP)

(72) Inventors: Harufumi MUTO, Miyoshi-shi (JP); Kazuya MATSUMOTO, Nagoya-shi (JP); Yosuke UENO, Nagoya-shi (JP); Hiroyasu YAMASHITA, Toyota-shi (JP)

(21) Appl. No.: 18/539,264

(22) Filed: Dec. 14, 2023

(30) Foreign Application Priority Data
Jan. 10, 2023 (JP) 2023-001693

(51) Int. Cl. G06F 40/258

(52) U.S. Cl. CPC G06F 40/258

(57) ABSTRACT

A sentence structure analysis system is provided. A line direction is a direction in which characters are arranged in a document. Headings are obtained from the document based on a position related to the line direction. The document is segmented into a first block and a second block. The first block includes one or more sentences from a first heading to a row preceding a second heading. The second block includes one or more sentences from the second heading to a row preceding a third heading.

### BACKGROUND

### 1. Field

The present disclosure relates to a sentence structure analysis system.

### 2. Description of Related Art

Japanese Laid-Open Patent Publication No. 2019-220038 discloses an example of a sentence analysis device. The sentence analysis device analyzes a document having a hierarchical structure to which headings such as a chapter, a section, and a clause are assigned. The sentence analysis device segments a document for each section by analyzing sentences included in the document.

Specifically, the sentence analysis device detects a style and an expression that are likely to be a section title. The sentence analysis device evaluates the detected style and expression to obtain sections from the document and segment the document for each section.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An aspect of the present disclosure provides a sentence structure analysis system that includes processing circuitry configured to provide a document, a line direction being a direction in which characters are arranged in the document, obtain headings from the document based on a position related to the line direction, the headings including a first heading, a second heading, and a third heading, the second heading being a heading following the first heading, and the third heading being a heading following the second heading, and segment the document into a first block and a second block, the first block including one or more sentences from the first heading to a row preceding the second heading, and the second block including one or more sentences from the second heading to a row preceding the third heading.

In the document, headings are described at substantially the same position in the line direction. By using the regularity of the sentence structure, the headings are extracted.

Thus, in the sentence structure analysis system, headings are obtained from the document based on the position related to the line direction. By obtaining headings in consideration of the sentence structure in this manner, the accuracy of heading extraction is increased. This allows the document to be segmented for each heading with high accuracy.

In a document to which one or more headings are assigned, there is no uniformity in the manner of assigning these headings, or there is an error in the headings. Even if the above process is performed on such a document, there is a possibility that the document cannot be correctly segmented for each section. The above configuration reduces such a risk.

Another aspect of the present disclosure provides a sentence structure analysis method for executing the same processes as those of the sentence structure analysis system.

A further aspect of the present disclosure provides a non-transitory computer-readable storage medium that stores a program that causes a processor to execute the same processes as those of the sentence structure analysis system.

Other features and aspects will be apparent from the following detailed description, the drawings, and the claims.

### BRIEF DESCRIPTION OF DRAWINGS

FIG. 1 is a block diagram illustrating the outline of a sentence structure analysis system according to an embodiment.

FIG. 2 is a diagram showing an example of a document to be analyzed by the sentence structure analysis system of FIG. 1.

FIG. 3 is a diagram showing an example of a document different from that shown in FIG. 2, which is analyzed by the sentence structure analysis system shown in FIG. 1.

FIG. 4 is a flowchart showing a series of processes executed by the sentence structure analysis system of FIG. 1.

FIG. 5 is a diagram including section (A) and section (B), each illustrating a display screen that shows the headings obtained from the sentence of FIG. 2 based on the flow of FIG. 4.

FIG. 6 is a diagram including section (A) and section (B), each illustrating a display screen that shows the headings obtained from the sentence of FIG. 3 based on the flow of FIG. 4.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the modes, devices, and/or systems described. Modifications and equivalents of the modes, devices, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, ‘at least one of A and B’ should be understood to mean ‘only A, only B, or both A and B.’

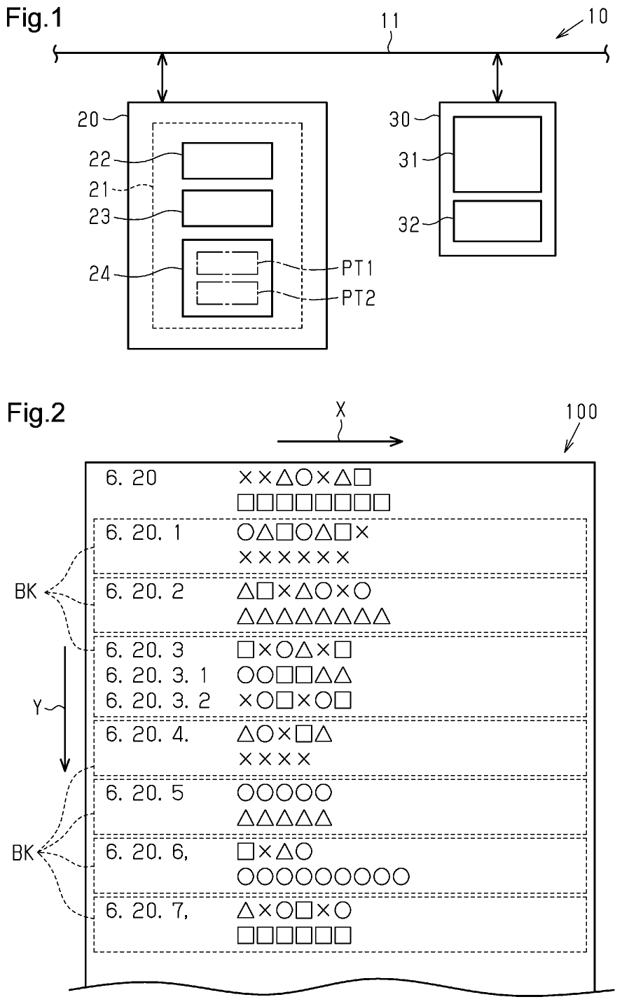

Hereinafter, an embodiment of a sentence structure analysis system according to the present disclosure will be described with reference to FIGS. 1 to 6.

As shown in FIG. 1, the sentence structure analysis system 10 is a system for analyzing a document. The sentence structure analysis system 10 includes an information processing device 20 and a terminal device 30. The terminal device 30 is configured to transmit and receive various types of information to and from the information processing device 20 via a communication line 11 such as a local area network (LAN).

### Document to be Analyzed

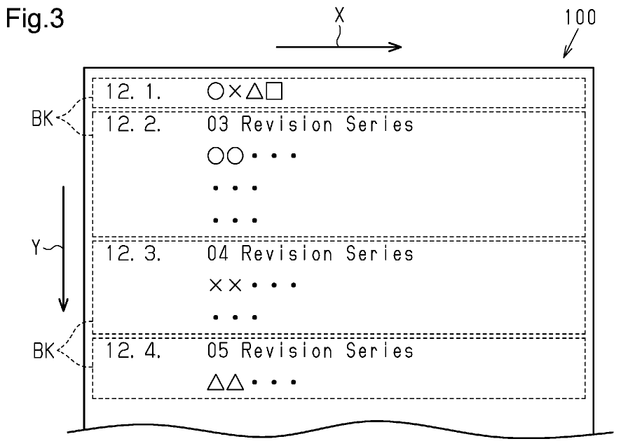

Referring to FIGS. 2 and 3, a document 100 to be analyzed by the sentence structure analysis system 10 will be described.

The document 100 includes sentences. The document 100 is a document having a hierarchical structure to which headings such as a chapter, a section and a clause are assigned. For example, the document 100 is a legal document. In the document 100 described above, the direction in which characters are arranged is referred to as a line direction, and the direction orthogonal to the line direction on the paper is referred to as a column direction. In the present embodiment, the line direction is referred to as an X-direction and the column direction is referred to as a Y-direction.

The document 100 is provided with a heading for each level. Each of the headings is assigned a heading number corresponding to the level. The heading number includes a number indicating the order of the heading. The heading of the first level, which is the highest level, is a chapter. A chapter number is assigned to the heading of the first level as a heading number. For example, for the heading indicating the sixth chapter, 6 is assigned to the beginning of the sentence as the heading number. The heading number is followed by a heading description.

The heading of the second level, which is one level below the first level, is a section. A chapter number and a section number are assigned to a heading that exists up to the second level as a heading number. For example, for the heading indicating the sixth chapter and the twentieth section, the heading number starts with 6, followed by 20. Further, in the heading, a heading description of the heading is arranged after the heading number.

The heading of the third level, which is one level below the second level, is a clause. A chapter number, a section number, and a clause number are assigned to a heading that exists up to the third level as a heading number. For example, for the heading indicating the sixth chapter, the twentieth section, and the first clause, the heading number starts with 6, followed by 20, and then 1. Further, in the heading, a heading description of the heading is arranged after the heading number.

In the document 100 having a hierarchical structure, the positions of the headings related to the X-direction are unified. In the examples shown in FIGS. 2 and 3, the first characters of the headings, specifically, the chapter number positions in the X-direction are unified.

### Information Processing Device

As shown in FIG. 1, the information processing device 20 includes processing circuitry 21. The processing circuitry 21 is, for example, a microcomputer. In this case, the processing circuitry 21 includes a CPU 22, a first memory 23, and a second memory 24. The first memory 23 stores a control program executed by the CPU 22. When the CPU 22 as a processor executes the control program, the processing circuitry 21 analyzes the document 100. Specifically, the processing circuitry 21 generates blocks BK by dividing the document 100 for each heading that exists up to the same level. The block BK is a group of sentences. For example, the first block includes one or more sentences from the first heading to a row preceding the second heading. The second block includes one or more sentences from the second heading to a row preceding the third heading. In FIG. 2, for example, 6.20.1 is the first heading. 6.20.2 is the second heading, 6.20.3 is the third heading, 6.20.4. is the fourth heading, 6.20.5 is the fifth heading, 6.20.6, is the sixth heading, and 6.20.7, is the seventh heading. In this case, the first block, the second block, the third block, . . . , and the seventh block are each indicated by the symbol BK and a broken line in FIG. 2.

The second memory 24 is a rewritable memory. The second memory 24 includes a regular pattern PT1 and an over-extracted pattern PT2.

When a heading to which a heading number is correctly assigned is defined as a regular heading, the regular pattern PT1 indicates a rule for marking the heading number of the regular heading. In the present embodiment, the regular pattern PT1 of the heading number assigned to the heading that exists up to the first level is ‘chapter number.’. That is, ‘.’ (period) is present after ‘chapter number’. The regular pattern PT1 of the heading number assigned to the heading that exists up to the second level is ‘chapter number. section number.’. That is, ‘.’ (period) is present after ‘section number’. The regular pattern PT1 of the heading number assigned to the heading that exists up to the second level is ‘chapter number. section number. clause number.’. That is, ‘.’ (period) is present after ‘clause number’. That is, a pattern in which the heading number ends with ‘.’ (period) is the regular pattern PT1.

The over-extracted pattern PT2 is used to extract a non-regular heading in addition to the regular heading. The non-regular heading is a similar heading. The similar heading is given a similar heading number according to the similar pattern. The similar pattern is similar to the regular pattern PT1 while being different from the regular pattern PT1. That is, the over-extracted pattern PT2 includes both the regular pattern PT1 and the similar pattern. The over-extracted pattern PT2 of the similar heading number assigned to the heading that exists up to the first level includes, for example, ‘chapter number’ and ‘chapter number*’ in addition to ‘chapter number.’. In the ‘chapter number’, there is no period after the ‘chapter number’. In ‘chapter number*’, ‘chapter number’ is followed by *. The over-extracted pattern PT2 of the heading number assigned to the heading that exists up to the second level includes, for example, ‘chapter number. section number’ and ‘chapter number. section number*’ in addition to ‘chapter number. section number.’. In ‘chapter number. section number’, there is no period after ‘section number’. In ‘chapter number. section number*’, ‘section number’ is followed by *. The over-extracted pattern PT2 of the heading number assigned to the heading that exists up to the third level includes, for example, ‘chapter number. section number. clause number’ and ‘chapter number. section number. clause number*’ in addition to ‘chapter number. section number. clause number.’. In ‘chapter number. section number. clause number’, there is no period after ‘clause number’. In ‘chapter number. section number. clause number*’, ‘clause number’ is followed by *. In other words, the similar pattern includes a chapter number, a section number, or a clause number but does not end with ‘.’ at the end of the heading number.

### Terminal Device

The terminal device 30 includes a display unit 31 and an operation unit 32 as user interfaces. The display unit 31 displays information sent from the information processing device 20, for example, an analysis result of the document 100. The operation unit 32 is operated by an operator based on information displayed on the display unit 31. The operation unit 32 includes, for example, a keyboard and a mouse. The terminal device 30 sends information corresponding to the operation of the operation unit 32 by the operator to the information processing device 20.

### Text Analysis Process

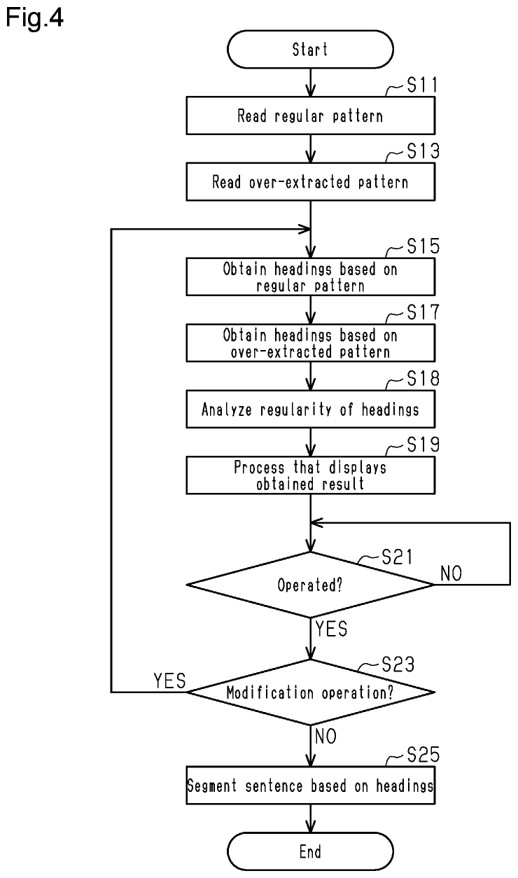

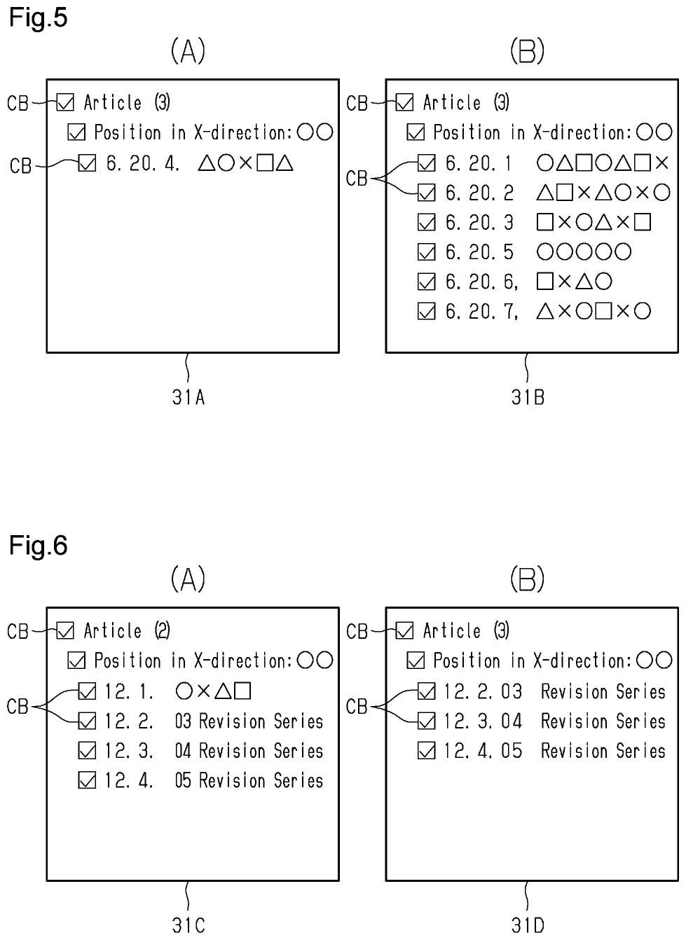

Referring to FIGS. 4 and 5, a sentence analysis process executed by the sentence structure analysis system 10 will be described. The sentence analysis process is the flow of a series of processes for analyzing the provided document 100 obtained by the information processing device 20 and classifying the document 100 for each heading that exists up to the same level.

In step S11, the processing circuitry 21 of the information processing device 20 reads the regular pattern PT1 from the second memory 24. In the next step S13, the processing circuitry 21 reads the over-extracted pattern PT2 from the second memory 24.

Subsequently, based on the position related to the X-direction, the processing circuitry 21 obtains one or more headings that exist up to the same level from the document 100 for each level. For example, the processing circuitry 21 obtains, from the document 100, one or more headings that exist up to the second level and one or more headings that exist up to the third level.

Specifically, in step S15, based on the regular pattern PT1, the processing circuitry 21 obtains the regular headings, which are headings to which regular heading numbers according to the regular pattern PT1 are assigned, from the document 100. For example, the regular pattern of the third level is ‘chapter number. section number. clause number.’. For example, it is assumed that the provided document 100 to be analyzed is the document shown in FIG. 2. In this case, the processing circuitry 21 obtains a heading to which ‘6.20.4.’ is assigned as a heading that exists up to the third level.

In step S17, the processing circuitry 21 obtain the similar headings to which similar heading numbers according to the similar pattern are assigned from the provided document 100 based on the over-extracted pattern PT2. For example, it is assumed that the over-extracted pattern PT2 for the third level includes ‘chapter number. section number. clause number.’ (there is a period after the clause number), ‘chapter number. section number. clause number’ (there is no period after the clause number), and ‘chapter number. section number. clause number*’ (there is * after the clause number). For example, it is assumed that the document 100 to be analyzed is the document shown in FIG. 2. The processing circuitry 21 obtains the heading to which ‘6.20.1’ is assigned, the heading to which ‘6.20.2’ is assigned, the heading to which ‘6.30.3’ is assigned, the heading to which ‘6.20.4.’ is assigned, and the heading to which ‘6.20.5’ is assigned as the headings that exist up to the third level. In ‘6.20.1’, there is no period after 1. In ‘6.20.2’, there is no period after 2. In ‘6.30.3’, there is no period after 3. Only in ‘6.20.4.’, a period is located after 4. In ‘6.20.5’, there is no period after 5. Among the headings obtained here, the heading with ‘6.20.4.’ has already been obtained in step S15. Therefore, the processing circuitry 21 excludes the heading of the regular pattern PT1 from the headings obtained based on the over-extracted pattern PT2. This allows the processing circuitry 21 to obtain, from the document 100, a similar heading (non-regular heading) to which a heading number according to the similar pattern is assigned.

In the subsequent step S18, the processing circuitry 21 divides the headings into at least one group by analyzing the regularity of the heading numbers assigned to the headings obtained in steps S15 and S17. For example, as the regularity of the heading numbers, the processing circuitry 21 analyzes up to which level the heading numbers of the headings exist up to and whether the heading number conforms to the regular pattern. For example, when the processing circuitry 21 has obtained both a heading that exists up to the second level and a heading that exists up to the third level, the processing circuitry 21 classifies the heading that exist up to the second level and the heading that exists up to the third level into groups different from each other. In addition, for example, in a case where a regular heading to which a heading number according to a regular pattern is assigned and a non-regular heading to which a heading number according to a similar pattern is assigned are obtained, the processing circuitry 21 classifies the regular heading and the non-regular heading into different groups.

The analysis process in a case where headings that exist up to the third level have been obtained from the provided document 100 shown in FIG. 2 will now be described. In this case, the headings obtained by the processing circuitry 21 are all headings that exist up to the third level. Some of the headings are assigned heading numbers in accordance with a regular pattern. The remaining headings are assigned heading numbers that do not conform to the regular pattern. Thus, the processing circuitry 21 divides the obtained headings into the first group and the second group. The first group includes one or more regular headings to which regular heading numbers according to a regular pattern are assigned. The second group includes one or more non-regular headings to which a non-regular heading number that does not conform to the regular pattern is assigned. The processing circuitry 21 sends the analysis result to the terminal device 30.

When the analysis result is sent from the information processing device 20 to the terminal device 30, the sentence structure analysis system 10 shifts the process to step S19.

In step S19, the terminal device 30 causes the display unit 31 to display the headings obtained by executing the processes in steps S15 and S17. In this step, the terminal device 30 executes the display process in consideration of the analysis result in step S18.

Referring to FIG. 5, the contents displayed on the display unit 31 when the headings that exist up to the third level have been obtained from the document 100 shown in FIG. 2 will be described. The terminal device 30 causes the display unit 31 to display a first display screen 31A shown in section (A) of FIG. 5 and a second display screen 31B shown in section (B) of FIG. 5. The first display screen 31A displays a regular heading to which a regular heading number according to the regular pattern PT1 is assigned. That is, the first display screen 31A displays the regular heading ‘6.20.4.’, which has been classified into the first group. In the first display screen 31A, ‘Article (3)’ indicates that a heading that exists up to the third level is displayed. For example, when it is indicated that a heading that exists up to the Nth level is displayed, ‘Article (N)’ is displayed. N is an integer greater than or equal to 1.

The second display screen 31B displays similar headings ‘6.20.1’, ‘6.20.2’, ‘6.20.3’, ‘6.20.5’, ‘6.20.6,’ and ‘6.20.7,’ to which similar heading numbers according to the similar pattern are respectively assigned. That is, the headings classified into the second group are displayed on the second display screen 31B. In the same manner, in the second display screen 31B, ‘Article (3)’ indicates that headings that exist up to the third level are displayed on the second display screen 31B.

In the first display screen 31A and the second display screen 31B, check boxes CB are arranged on the left side of ‘Article (3)’ and the left side of the heading, respectively. As shown in sections (A) and (B) of FIG. 5, the check boxes CB are checked by default. When the check boxes CB on the left side of the headings is checked, it indicates that the headings on the right side of the checked check boxes CB are correctly obtained by the processing circuitry 21. Thus, when there is a heading erroneously obtained by the processing circuitry 21, the operator needs to uncheck the check box CB on the left side of the erroneously-obtained heading by operating the operation unit 32. For example, in the second display screen 31B, when the heading with ‘6.20.2’ (no period after 2) at the beginning is erroneously obtained by the processing circuitry 21, the operator unchecks the check box CB on the left side of the heading with ‘6.20.2’ at the beginning by operating the operation unit 32.

For example, when the check box CB on the left side of ‘Article (3)’ is unchecked, the check boxes CB on the left side of all the headings displayed under ‘Article (3)’ are unchecked.

Referring back to FIG. 4, after displaying the result of obtaining the heading on the display unit 31 in step S19, the terminal device 30 advances the process to step S21. In step S21, the terminal device 30 determines whether the operation of the operation unit 32 by the operator is completed.

When the result of obtaining the heading is displayed on the display unit 31, the operator determines whether there is excess or deficiency in the heading obtaining while seeing the display unit 31. When the operator determines that neither excessive acquisition of headings nor omission of acquisition of headings is present, the operator performs an operation for advancing the process.

When there is excessive acquisition of the headings, the operator unchecks the check box CB on the left side of the erroneously-obtained heading as described above.

In addition, when there is omission of acquisition of headings, the operator performs an operation for modifying the over-extracted pattern PT2. For example, if the over-extracted pattern PT2 for the third level does not include ‘chapter number. section number. clause number,’ (there is a comma after the clause number), the following problem may occur. The processing circuitry 21 may be unable to obtain the heading to which ‘6.20.6,’ (a comma exists after 6) and the heading to which ‘6.20.7,’ (a comma exists after 7) from the document 100 illustrated in FIG. 2. Therefore, the operator operates the operation unit 32 so that the over-extracted pattern PT2 for the third level is modified (updated) to include ‘chapter number. section number. clause number,’ (there is a comma after the clause number). Such an operation of the operation unit 32 for modifying the over-extracted pattern PT2 is referred to as a modification operation in the present specification.

When determining that the operation of the operation unit 32 by the operator is not completed (S21: NO), the terminal device 30 repeats determination of step S21 until determining that the operation is completed. When determining that the operation of the operation unit 32 by the operator is completed (S21: YES), the terminal device 30 advances the process to step S23.

In step S23, the processing circuitry 21 of the information processing device 20 determines whether the operation performed by the operator on the terminal device 30 is the modification operation. When the operation by the operator is the modification operation (S23: YES), the processing circuitry 21 shifts the process to step S15. In this case, the processing circuitry 21 executes again the acquisition of headings based on the regular pattern PT1 in step S15 and the acquisition of headings based on the over-extracted pattern PT2 after the modification in step S17.

In step S23, when the operation performed by the operator on the terminal device 30 is not the modification operation (S23: NO), the processing circuitry 21 advances the process to step S25. In step S25, the processing circuitry 21 segments the document 100 into blocks based on the headings that have been obtained from the document 100 by the processing circuitry 21. Specifically, the processing circuitry 21 defines, as one block BK, documents from the first heading to a row preceding the second heading among headings. The second heading is a heading following the first heading. Further, the processing circuitry 21 defines, as one block BK, documents from the second heading to a row preceding the third heading. The third heading is a heading following the second heading.

When the segmentation of the document 100 for each heading is completed in this manner, a series of processes is ended in the sentence structure analysis system 10.

### Operation of Present Embodiment

Referring to FIGS. 2 and 5, the operation when the information processing device 20 analyzes the document 100 shown in FIG. 2 will be described. Here, a case in which the document 100 is segmented for each heading that exists up to the third level will be described.

In the information processing device 20, based on the position in the X-direction in the document 100 and the regular pattern, the headings that exist up to the third level to which the heading numbers according to the regular pattern PT1 are respectively assigned is obtained (S15). Further, based on the position in the X-direction in the document 100 and the over-extracted pattern PT2, the headings that exist up to the third level and to which the heading numbers according to the similar pattern is assigned are obtained (S17).

In a comparative example, the over-extracted pattern PT2 for the third level includes ‘chapter number. section number. clause number.’ (i.e., there is a period after clause number), ‘chapter number. section number. clause number’ (i.e., there is no symbol after clause number), and ‘chapter number. section number. clause number*’ (i.e., there is * after clause number). However, it is assumed that the over-extracted pattern PT2 does not include ‘chapter number. section number. clause number,’ (that is, there is a comma after the clause number).

In this case, the information processing device 20 obtains the heading to which ‘6.20.1’ is assigned, the heading to which ‘6.20.2’ is assigned, the heading to which ‘6.20.3’ is assigned, the heading to which ‘6.20.4.’ is assigned, and the heading to which ‘6.20.5’ is assigned from the document 100. The information processing device 20 does not obtain the heading to which ‘6.20.6,’ is assigned and the heading to which ‘6.20.7,’ is assigned from the document 100. Thus, in the comparative example, there is a possibility that the heading with ‘6.20.6,’ and the heading with ‘6.20.7,’ are not displayed on the second display screen 31B indicating the obtained result (S19).

However, the present embodiment allows the operator to add ‘chapter number. section number. clause number,’ to the over-extracted pattern PT2 by performing the modification operation (S21). When such a modification operation is performed (S23: YES), the process of obtaining the heading from the document 100 is executed again (S15, S17, and S18). Then, the information processing device 20 also obtains the heading with ‘6.20.6,’ and the heading with ‘6.20.7,’ from the document 100.

As a result, as shown in section (B) of FIG. 5, the second display screen 31B also displays the heading with ‘6.20.6,’ and the heading with ‘6.20.7,’ (S19).

When the operator confirms that there is no excess or deficiency in the acquisition of the headings (S23: NO), the information processing device 20 segments the document 100 for each of the obtained headings (S25). As a result, as shown in FIG. 2, the block BK for each heading that exists up to the third level is generated.

Next, referring to FIGS. 3 and 6, an operation when the information processing device 20 analyzes the document 100 shown in FIG. 3 will be described.

The information processing device 20 obtains the headings that exist up to the second level to which the heading numbers according to the regular pattern PT1 are assigned (S15). The headings are obtained based on the position in the X-direction in the document 100 and the regular pattern PT1. Specifically, the processing circuitry 21 obtains the heading to which ‘12.1.’ is assigned, the heading to which ‘12.2.’ is assigned, the heading to which ‘12.3.’ is assigned, and the heading to which ‘12.4.’ is assigned as the headings that exist up to the second level.

Here, in the document 100 shown in FIG. 3, a sentence starting with ‘03’ is described following ‘12.2.’. For example, on the right side of the heading ‘12.2.’, a sentence starting with ‘03 revision series’ is described. That is, the heading ‘12.2.03’ is not described in the document 100. Similarly, a sentence starting with ‘04’ is described following ‘12.3.’. In addition, a sentence starting with ‘05’ is described following ‘12.4.’.

However, the information processing device 20 may obtain the heading to which ‘12.2.03’ is assigned, the heading to which ‘12.3.04’ is assigned, and the heading to which ‘12.4.05’ is assigned as the headings up to the third level based on the position related to the X-direction in the document 100 and the over-extracted pattern PT2.

In the sentence structure analysis system 10, the processing circuitry 21 analyzes the regularity of the heading numbers that are respectively assigned to the obtained headings (S18). In the example described here, some of the obtained headings are headings that exist up to the second level. Here, the heading to which ‘12.1.’ is assigned, the heading to which ‘12.2.’ is assigned, the heading to which ‘12.3.’ is assigned, and the heading to which ‘12.4.’ is assigned are headings that exist up to the second level. The remaining headings are headings that exist up to the third level. That is, the heading to which ‘12.2.03’ is assigned, the heading to which ‘12.3.04’ is assigned, and the heading to which ‘12.4.05’ is assigned are headings that exist up to the third level. Therefore, the headings that exist up to the second level are classified into the first group. The headings that exist up to the third level are classified into the second group. Here, the over-extracted pattern PT2 is a specific pattern. The headings included in a specific group were incorrectly obtained. That is, the heading with ‘12.2.03’, the heading with ‘12.3.04’, and the heading with ‘12.4.05’ were erroneously obtained. The second group is the specific group.

Then, a third display screen 31C shown in section (A) of FIG. 6 and a fourth display screen 31D shown in section (B) of FIG. 6 are displayed on the display unit 31 of the terminal device 30 (S19). The third display screen 31C displays the headings that exists up to the second level. The fourth display screen 31D displays the headings that exist up to the third level. That is, the third display screen 31C shown in section (A) of FIG. 6 displays the headings that has been classified into the first group. The third display screen 31C shown in section (B) of FIG. 6 displays the headings that has been classified into the second group.

When the headings that exists up to the third level displayed on the fourth display screen 31D shown in the section (B) of FIG. 6 are erroneously-obtained headings, the operator unchecks the check box CB on the left side of ‘Article (3)’ on the fourth display screen 31D shown in the section (B) of FIG. 6. As a result, the heading to which ‘12.2.03’ is assigned, the heading to which ‘12.3.04’ is assigned, and the heading to which ‘12.4.05’ is assigned are deleted from the headings obtained by the processing circuitry 21. Thus, the document 100 is prevented from being segmented by the heading with ‘12.2.03’, the heading with ‘12.3.04’, and the heading with ‘12.4.05’ (S25). Consequently, as shown in FIG. 3, the block BK is generated for each of the headings ‘12.1.’, ‘12.2.’, ‘12.3.’, and ‘12.4.’ that exist up to the second level.

### Advantages of Present Embodiment

(1) The sentence structure analysis system 10 obtains headings of a certain level from the document 100 based on the position related to the X-direction in the document 100. By obtaining a heading in consideration of the structure of the document 100 in this manner, the accuracy of heading extraction is increased. This allows the document 100 to be segmented for each heading with high accuracy.
(2) The sentence structure analysis system 10 stores the over-extracted pattern PT1 in addition to the regular pattern PT2 in the second memory 24 of the information processing device 20. This allows the processing circuitry 21 to obtain not only a heading to which a heading number according to the regular pattern PT1 is assigned but also a heading to which a heading number according to the similar pattern is assigned. As a result, the omission of heading acquisition is less likely to occur.
(3) The processing circuitry 21 cannot obtain a heading to which a heading number of a pattern that is not included in the over-extracted pattern PT2 is assigned. In this regard, when the acquisition of the headings is completed, the sentence structure analysis system 10 displays all the obtained headings on the display unit 31. This allows the operator to check whether there is a heading acquisition omission by, for example, comparing the display unit 31 with the document 100. When the operator finds the omission of acquisition of the heading, the over-extracted pattern PT2 can be added or expanded by a modification operation by the operator. When such a modification operation is performed on the over-extracted pattern PT2, the process of obtaining the heading is executed again. Since the over-extracted pattern PT2 is able to be changed as described above, the effect of preventing the heading acquisition from being omitted is enhanced.
(4) Upon obtaining headings, the processing circuitry 21 analyzes the regularity of the heading numbers respectively assigned to the headings. The processing circuitry 21 divides the headings into at least one group. When the headings are classified into groups, the terminal device 30 causes the display unit 31 to display a display screen for each group. For example, the display screen of a group of the first pattern, the display screen of a group of the second pattern, and the like are displayed on the display unit 31. For example, when the headings classified into the first group among the groups are erroneously obtained, the operator can collectively delete the headings classified into the first group. This prevents the document 100 from being segmented by an erroneously-obtained heading.

### Modifications

The above embodiment may be modified as follows. The above embodiment and the following modifications can be combined as long as the combined modifications remain technically consistent with each other.

After obtaining the heading based on the regular pattern PT1 and obtaining the heading based on the over-extracted pattern PT2, the result of obtaining the headings is displayed on the display unit 31. For example, as shown in section (A) of FIG. 6, the result of obtaining the headings based on the regular pattern PT1 is shown. At this time, if there is an omission in obtaining the headings, for example, a heading with ‘12.3.’ may be displayed next to a heading with ‘12.1.’. In this case, the processing circuitry 21 can determine that there is a possibility that the heading to which ‘12.2.’ is assigned cannot be obtained. Thus, the processing circuitry 21 simply needs to output, to the terminal device 30, a command for notifying the operator that there is a possibility that the omission of heading acquisition has occurred. In this case, the operator operates the operation unit 32 to correct the regular pattern PT1 and the over-extracted pattern PT2 so that the processing circuitry 21 can obtain the heading that has been omitted from being obtained.

The document to be analyzed may be a document other than a legal document as long as it is a document having a hierarchical structure to which headings are assigned. The other documents may include, for example, product instructions and specifications, regulation documents, and treatises.

In the above embodiment, as shown in FIGS. 2 and 3, the processing circuitry 21 segments the horizontally-written document for each heading. However, this configuration does not have to be employed. Instead, the processing circuitry 21 may segment a vertically-written document for each heading.

Since the document to be analyzed may be a document having a hierarchical structure, it may be a document having any hierarchy. For example, the document 100 may be a three-level document, a four-level document, or a five-level document.

In the above embodiment, the headings obtained by the processing circuitry 21 are divided into groups based on the regularity of the heading numbers. The display unit 31 of the terminal device 30 displays the display screen for each group. However, this configuration does not have to be employed. For example, the process of dividing the headings obtained by the processing circuitry 21 into groups based on the regularity of the heading numbers does not have to be executed. In this case, the display unit 31 of the terminal device 30 may display a display screen on which all headings are displayed. Preferably, the terminal device 30 causes display unit 31 to display all headings so that the heading numbers are arranged in order.

In the above embodiment, the check box CB is used as a means for selecting a correctly-obtained heading from headings that have been obtained. However, this configuration does not have to be employed. One of a correctly-obtained heading and an erroneously-obtained heading may be selected from the obtained headings. That is, a selection means other than the check box CB may be employed.

All of the heading numbers of headings provided in a document may be numbers assigned according to a regular pattern. That is, the over-extracted pattern PT2 does not have to be provided.

In the above embodiment, a heading may be obtained from a document based on a position related to the X-direction. Thus, the pattern in the heading number does not have to be taken into consideration.

The processing circuitry 21 is not limited to a device that includes a CPU and a ROM and executes software processing. That is, the processing circuitry 21 may be modified as long as it has any one of the following configurations (a) to (c).
(a) The processing circuitry 21 includes one or more processors that execute various processes in accordance with a computer program. The processor includes a CPU and a memory, such as a RAM and ROM. The memory stores program codes or instructions configured to cause the CPU to execute the processes. The memory, or a non-transitory computer-readable storage medium, includes any type of media that are accessible by general-purpose computers and dedicated computers.
(b) The processing circuitry 21 includes one or more dedicated hardware circuits that execute various processes. Examples of the dedicated hardware circuits include an application specific integrated circuit (ASIC) and a field programmable gate array (FPGA).
(c) The processing circuitry 21 includes a processor that executes part of various processes in accordance with a computer program and a dedicated hardware circuit that executes the remaining processes.

The phrase ‘at least one of’ as used in this description means ‘one or more’ of a desired choice. For example, the phrase ‘at least one of’ as used in this description means ‘only one choice’ or ‘both of two choices’ in a case in which the number of choices is two. In another example, the phrase ‘at least one of’ as used in this description means ‘only one single choice’ or ‘any combination of two or more choices’ if the number of its choices is three or more.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A sentence structure analysis system, comprising processing circuitry configured to:
provide a document, wherein a line direction is a direction in which characters are arranged in the document;
obtain headings from the document based on a position related to the line direction, wherein the headings include a first heading, a second heading, and a third heading, the second heading is a heading following the first heading, and the third heading is a heading following the second heading; and
segment the document into a first block and a second block, wherein the first block includes one or more sentences from the first heading to a row preceding the second heading, and the second block includes one or more sentences from the second heading to a row preceding the third heading.

2. The sentence structure analysis system according to claim 1, wherein
heading numbers are respectively assigned to the headings to indicate an order of the headings,
the headings include one or more regular headings to which one or more regular heading numbers according to a regular pattern are assigned and one or more similar headings to which one or more similar heading numbers according to a similar pattern are assigned,
the similar pattern is similar to the regular pattern while being different from the regular pattern, and
when obtaining the headings, the processing circuitry is configured to:
obtain the one or more regular headings from the document based on the regular pattern; and
obtain the one or more similar headings from the document.

3. The sentence structure analysis system according to claim 2, wherein the processing circuitry is configured to:
divide the headings into groups by analyzing regularity of the heading numbers that are respectively assigned to the headings, wherein the groups include a specific group in a specific pattern, and a heading included in the specific group is erroneously obtained; and
prevent the document from being segmented by the heading included in the specific group.

4. The sentence structure analysis system according to claim 1, wherein
the document is a legal document, and
the processing circuitry is configured to segment, for each of the headings, the legal document into blocks that include the first block and the second block.
